(19) United States
(12) Patent Application Publication
(10) Pub. No.: US 2004/0003712 A1
(43) Pub. Date: Jan. 8, 2004

(54) Reduced weight guide link

(76) Inventors: Christopher C. Langenfeld, Nashua, NH (US); Stanley B. Smith III, Raymond, NH (US)

Correspondence Address: BROMBERG & SUNSTEIN LLP, 125 SUMMER STREET, BOSTON, MA, 02110-1618, US

(21) Appl. No.: 10/615,540

(22) Filed: Jul. 8, 2003

Related U.S. Application Data
(63) Continuation-in-part of application No. 09/883,080, filed on Jun. 15, 2001, now Pat. No. 6,591,608.
Application No. 09/883,080 is a continuation-in-part of application No. 09/335,392, filed on Jun. 17, 1999, now Pat. No. 6,253,550.

(51) Int. Cl. F16J 15/18

(52) U.S. Cl. 92/165 R

(57) ABSTRACT

An improvement for a system for supporting lateral loads on a piston undergoing reciprocating motion along a longitudinal axis in a cylinder includes a guide link for coupling the piston to a crankshaft undergoing rotary motion about a rotation axis of the crankshaft where the longitudinal axis and the rotation axis are substantially orthogonal to each other. The improvement includes a guideway insert for the guide link that facilitates fabricating the guide link from materials with different wear-resistance characteristics.

### CROSS REFERENCE TO RELATED APPLICATIONS

The present application is a continuation-in-part of U.S. patent application Ser. No. 09/883,080, filed Jun. 15, 2001, attorney's docket 2229/128, which is a continuation-in-part of U.S. patent application Ser. No. 09/335,392, attorney's docket 2229/104, filed Jun. 17, 1999 and now issued as U.S. Pat. No. 6,253,550, which are all herein incorporated by reference.

### TECHNICAL FIELD

The present invention pertains to improvements to an engine and more particularly to improvements relating to mechanical components of a Stirling cycle heat engine or refrigerator which contribute to increased engine operating efficiency and lifetime.

### BACKGROUND OF THE INVENTION

A major problem encountered in the design of certain engines, including the compact Stirling engine, is that of the friction generated by a sliding piston resulting from misalignment of the piston in the cylinder and lateral forces exerted on the piston by the linkage of the piston to a rotating crankshaft. Referring now to the engine portion 100 shown in FIG. 1, as described in U.S. Pat. No. 6,253,550, it is known that in order to reduce the lateral forces on the piston, a guide link 103 may be used as a guidance system to take up lateral forces while keeping the motion of piston 14 constrained to linear motion. In a guide link design, a connecting rod is replaced by the combination of guide link 103 and a connecting rod 105. Guide link 103 is rotatably connected to the connecting rod 105 at a crank-pin 108. Guide link 103 is aligned with the wall 101 of piston cylinder 14 and is constrained to follow linear motion by a set of guide wheels 109, 111. A guide link will generally increase the size of the crankcase because the guide link must be of sufficient length that when the piston is at its maximum extension into the piston cylinder, the guide link extends beyond the piston cylinder so that the guide wheels maintain contact and alignment with the guide link. However, the folded guide link, as disclosed in U.S. Pat. No. 6,253,550, can reduce the size of the crankcase.

Guide link 103 is subject to wear at those points where rollers 109 and 111 contact the guide link. Constructing the guide link of a durable material, for example, a hardened metal, may significantly increase the weight of the engine. For certain applications, such as transportation, lighter weight engines are preferable.

### SUMMARY OF THE INVENTION

In accordance with an aspect of the invention, a method of manufacturing a reduced-weight guide link for a thermal cycle engine is provided. The method includes fabricating a guide link from a lightweight material; providing inserts of a material that is more wear-resistant that the guide link, and securing the inserts to the guide-link as guideways for the guide wheels. In this way the guide link may better withstand the constant wear from the guide wheel as the wheel traverses the guide-way, while the engine reciprocates. The balance of the guide-link may be fabricated from lighter weight materials that need not withstand the constant wear of the guide wheels. In this way, a lighter guide-link may be fabricated and other components within the engine may be correspondingly reduced in weight, achieving a substantial weight reduction for the engine.

The guideway inserts may be fabricated from a hardened metal or a ceramic material. The insert may be coated to further increase wear resistance. The shape of the insert may be any shape that mates with a guide wheel surface shape. In specific embodiments of the invention, the insert may be shaped as a cylinder, may have a square cross-section or, may be V-shaped in the faces that the insert presents to the guide wheel.

### BRIEF DESCRIPTION OF THE DRAWINGS

The invention will be more readily understood by reference to the following description, taken with the accompanying drawings, in which:

FIG. 1 is a cross-sectional view of a folded guide link linkage for an engine;

FIG. 2 is a perspective view of an embodiment of a reduced weight guide link;

FIG. 3 is a perspective view of the guide link of FIG. 2 shown without guide wheels; and

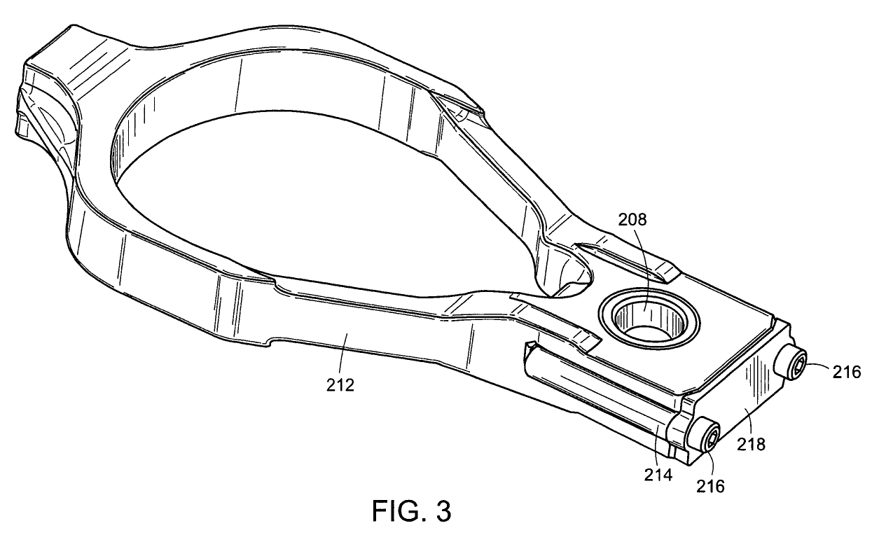

FIG. 4 is a cross sectional view of alternative insert and guideway shapes.

### DETAILED DESCRIPTION OF PREFERRED EMBODIMENTS

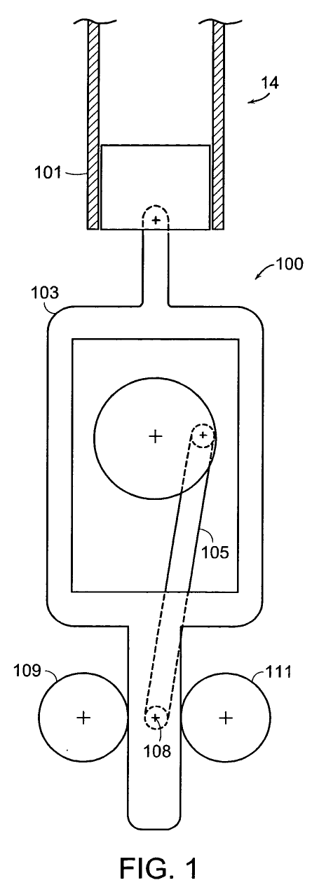

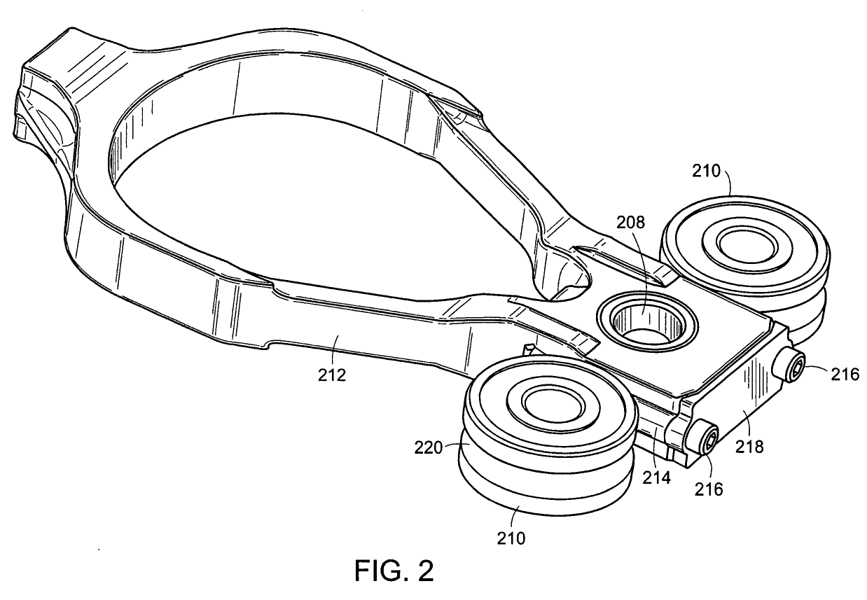

An improvement to a guide link for a reciprocating engine, according to an embodiment of the invention, is shown in FIG. 2. This guide link may be used, for example, in the embodiment of FIG. 1 in place of the guide link 103. The guide link 212 transfers axial loads from the crank-pin 208 to the piston connected at the top of the guide link 212. The guide link also transfers the transverse loads from the crank-pin 208 to the guide wheels 210. In addition to carrying the loads, the guide link must provide a hard and wear-resistant surface to contact the guide wheels. Although lightweight alloys such as aluminum, magnesium or titanium can carry the loads, these materials would quickly wear away under the guide wheels. In this embodiment, two guideway inserts 214 are installed in a guide link 212 that may be fabricated from material different from that used in the inserts. The guideway inserts 214 resist wear caused by the guide wheels 220, while the guide link carries the load between the crank pin 208 and the piston. (One of the insert is not shown in FIG. 2.) This design separates the load carrying function from the wear function, allowing each to be optimized. Thus, a lighter weight material may be used for the guide link 212, than would be possible if the guide link were of unitary design.

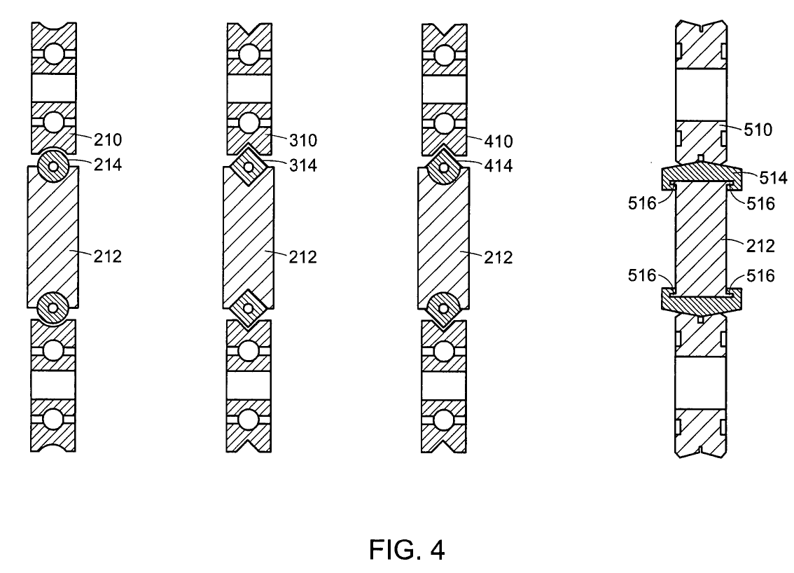

A number of alternative cross-sections may be used for the guide wheels 210 and guideway inserts 214. For example, the cross-sectional alternatives shown in FIG. 4 may be used. In a specific embodiment of the invention, the guide wheels 210 are commercially available bearings with circular grooves 220 on the outside diameter. Cylindrical guide-way inserts 214 are secured to the guide link 212 by screws 216 and an end plate 218. These inserts are shown in cross-section in FIG. 4. In an alternative embodiment, commercially available bar-stock is used for the guideway inserts 314 and is mated with a “V”-wheel for the guide wheels 310, as shown in FIG. 4. This insert has a square cross-section. In a further alternative embodiment, custom guideway inserts 414 are paired with “V” wheels for the guide wheels 410. These guideway inserts 414 present a V-shaped face to the guide wheels. The insert face(s) that contact the guide link may be a partial cylinder in cross-section or another shape. The term “V-shaped insert” as used in this specification and in any appended claims will mean an insert which presents a V-shaped face to a guide wheel and presents an arbitrarily shaped face to a guide link. In a further alternative embodiment, “V”-shaped guideway inserts 514 are also paired with “V” wheels for the guide wheels 510. The inserts 514 slip over tabs 516 extending from the guide link 212. These inserts 514 may be secured to the guide link by an endplate 218 that may be secured to the guide link by screws 216.

In a preferred embodiment, chrome steel hardened to 59 to 65 Rockwell Hardness C is used for the guideway inserts. In this specification and in any appended claims, unless context requires otherwise, the term “hardened” as applied to a material shall indicate material hardened to 55C or greater on the Rockwell Hardness scale. In other embodiments, other materials including tool steels and other wear-resistant materials may be used for the insert. In order to further increase wear resistance, the guideway inserts 214 may be coated with extremely hard materials. In preferred embodiments, coatings such as TiN (titanium nitride) and DLC (diamond like carbon) may be used.

Reducing the weight of any one reciprocating part of a guide link drive can reduce the total drive weight by a factor of four. This four-fold reduction comes from the balancing requirements. The rotating counter weights may be lightened to match the lightened guide link and the perpendicular piston and its counterweight may be equally reduced to provide a balanced drive. Embodiments of the invention may be used advantageously to reduce the weight of the engine for applications where engine weight is important.

The devices and methods described herein may be applied in other applications besides the Stirling engine in terms of which the invention has been described. The described embodiments of the invention are intended to be merely exemplary and numerous variations and modifications will be apparent to those skilled in the art. All such variations and modifications are intended to be within the scope of the present invention as defined in the appended claims.

We claim:

1. A method for manufacturing a reduced weight guide link for an engine, the method comprising:
a. providing the guide link;
b. providing a guideway insert; and
c. securing the insert to the guide link as a guideway for a guide wheel, such that the wear resistance of the insert is greater than the wear resistance of the guide link.

2. A method according to claim 1, further including:
d. coating the insert to increase the wear-resistance.

3. A method according to claim 2, wherein coating the insert includes coating with titanium nitride.

4. A method according to claim 2, wherein coating the insert includes coating with diamond-like-carbon.

5. A method according to claim 1, wherein the insert is cylindrical.

6. A method according to claim 1, wherein the insert has a square cross-section.

7. A method according to claim 1, where the insert is V-shaped.

8. A method according to claim 1, wherein the insert is alloy steel

9. A method according to claim 1, wherein the insert is tool steel.

10. A method according to claim 1, wherein the insert is a ceramic.

11. A method according to claim 1, wherein the insert is hardened metal.

12. A method according to claim 1, wherein the insert is secured to the guide link with an end plate.

13. A lightweight guide link assembly for an engine, the assembly comprising:
a. a guide link; and
b. a guideway insert for providing a guideway for a guide wheel, such that the wear resistance of the insert is greater than the wear resistance of the guide link.

14. A guide link assembly according to claim 13, wherein the insert is coated to increase the wear resistance.

15. A guide link assembly according to claim 14, wherein the insert is coated with titanium nitride.

16. A guide link assembly according to claim 14, wherein the insert is coated with diamond-like-carbon.

17. A guide link assembly according to claim 13, wherein the insert has a square cross section.

18. A guide link assembly according to claim 13, wherein the insert is cylindrical.

19. A guide link assembly according to claim 13, wherein the insert is V-shaped.

20. A guide link assembly according to claim 13, wherein the insert is a hardened metal.

21. A guide link assembly according to claim 13, wherein the insert is alloy steel.

22. A guide link assembly according to claim 13, wherein the insert is tool steel.

23. A guide link assembly according to claim 13, wherein the insert includes a ceramic.

24. A guide link assembly according to claim 13, wherein the insert is secured to the guide link with an end plate.
